(19) United States
(12) Patent Application Publication
(10) Pub. No.: US 2014/0120395 A1
(43) Pub. Date: May 1, 2014

(54) CELL COIL OF A LITHIUM ION RECHARGEABLE BATTERY AND METHOD FOR PRODUCING A CELL COIL

(71) Applicant: Joerg Ziegler, Rutesheim (DE)

(72) Inventor: Joerg Ziegler, Rutesheim (DE)

(21) Appl. No.: 14/113,809

(22) PCT Filed: Feb. 28, 2012
(86) PCT No.: PCT/EP2012/053294

§ 371 Date: Jan. 9, 2014

(30) Foreign Application Priority Data
Apr. 27, 2011 (DE) 102011017613.6

(51) Int. Cl. H01M 10/0587; H01M 10/04

(52) U.S. Cl. CPC H01M 10/0587; H01M 10/0431
USPC 429/94; 29/623.1; 29/623.5

(57) ABSTRACT

The invention relates to a cell coil of a lithium ion rechargeable battery, including at least two conductors (90) and at least two separators, the conductors (90) being separated from one another by the separators; the active material (92) being applied onto the conductors (90); the thickness (94) of the active material varying along the conductors (90). By varying the thickness (94) of the active material along the conductors (90), the service life of the cell coil is increased and an increased storage capacity is able to be implemented.

### BACKGROUND OF THE INVENTION

1. Field Of The Invention

The present invention relates to a cell coil of a lithium ion rechargeable battery including at least two conductors and at least two separators, the conductors being separated from one another by the separators; active material being applied onto the conductors; the thickness of the active material varying along the conductors.

2. Description Of The Related Art

Lithium ion rechargeable batteries are electrochemical energy stores having high specific energy and specific power. They are used in cell phones, laptops, electric tools, for example, and in the future will be used increasingly in vehicles. Cylindrical lithium ion rechargeable batteries, lithium ion rechargeable batteries having stacked electrodes and so-called prismatic cells, in which the electrodes and the separators are wound “prismatically” are known in principle.

Mechanical stresses of the active material are created by the winding of the electrodes. The narrower the radius of the winding and the thicker the active material layer, the stronger is the mechanical stress. The active material layers experience an additional mechanical stress during the charging and discharging of the lithium ion rechargeable battery, because the active materials change because of the intercalation/deintercalation of lithium in their volume.

### BRIEF SUMMARY OF THE INVENTION

The subject matter of the present invention is a cell coil of a lithium ion rechargeable battery, including at least two conductors and at least two separators, the conductors being separated from one another by the separators; and the active material being applied onto the conductors wherein the thickness of the active material varies along the conductors.

According to the present invention, the cell coil of the lithium ion rechargeable battery thus includes at least two conductors and at least two separators. The first conductor may, for instance, represent a positive electrode or cathode, and be made of aluminum. The second conductor may, for instance, represent a negative electrode or anode, and be made of copper. The conductors may have different shapes. Normally, the two conductors represent metallic foils. The two separators separate the two conductors from each other. The two separators are typically made of porous polyethylene and/or polypropylene. The separators are laid between the conductors, and thus prevent direct contact of the conductors and thereby prevent a short circuit within the cell coil. The active material is applied onto the two conductors. Normally, the active material is applied on both sides of the two conductors, in this context.

According to the present invention, the thickness of the active material varies along the conductors. This means that the thickness of the active material along the conductors varies in the direction in which the cell coil is wound during production. However, the thickness of the active material may also vary along the conductors in the direction that is transverse to the direction in which the cell coil is wound during production. The thickness of the active material along the first conductor may differ from the thickness of the active material along the second conductor. Because of the variation of the thickness of the active material, the conductors and the active material applied onto the conductor experience differently high mechanical stresses during bending or during the winding of the cell coil, respectively. These result from the height or thickness, as seen in cross section, of the conductor together with the active material applied onto it. In this instance, the cross section is seen in the direction in which the cell coil is wound during production.

By varying the thickness of the active material, the maximally occurring stresses are varied, since they are a direct function of the height of the cross section. Now, if the cell coil of the lithium ion rechargeable battery undergoes an expansion, for instance, based on a thermal and/or mechanical stress, the stresses resulting from this are reduced because of the varied thickness. Locations at which only slight mechanical or thermal stresses are to be expected, may thus correspondingly demonstrate a great thickness of the active material. Furthermore, the cell coil experiences a mechanical stress during charging and discharging of the lithium ion rechargeable battery. This mechanical stress results from the volume change of the active material because of the intercalation/deintercalation of lithium. The stresses in the active material layer are able to be affected in a targeted manner by the variation of the thickness of the active material. By varying the thickness of the active material, the service life of the cell coil is increased, because the active material is no longer able to flake off in the stressed areas. Moreover, the specific energy [Wh/kg] and the volumetric energy density [Wh/m³] of the cell are able to be increased. It is true that, at the more greatly stressed regions of the cell coil, less active material is applied, but more active material is applied at the less stressed regions. Furthermore, using this invention, any shapes of the cell coil are able to be produced in a manner that avoids stressing. Thus, for example, cell coils may be produced that have a prismatic, rectangular or spiral shape or a round shape.

According to one refinement of the cell coil, the thickness of the active material varies along the conductor as a function of the radius of curvature of the conductors.

Because the thickness of the active material along the conductor is varied as a function of the radius of curvature of the conductors, the thickness of the active material is reduced at places at which increased stresses are to be expected.

According to one refinement of the cell coil, the thickness of the active material varies along the conductor in proportion to the radius of curvature of the conductors.

Independently of outer stresses, such as mechanical or thermal stresses, the cell coil experiences mechanical stress by bending during its production, because of the rolling up to form a cell coil. While the active material varies along the conductor proportional to the radius of curvature of the conductor, active material is applied at places which are bent, in proportion to the radius of curvature. This reduces the stress load within the active material, since for small radii of curvature a slight thickness of the active material is provided, and correspondingly, for large radii of curvature a large thickness of the active material is provided. A straight conductor has a radius of curvature which tends to infinity. A straight conductor thus has the greatest possible radius of curvature. A buckled conductor has a radius of curvature which tends to zero. Thus, a buckled conductor has the least possible radius of curvature.

According to one refinement of the cell coil
the thickness of the active material at places having a relatively small radius of curvature of the conductors is a minimum and/or
the thickness of the active material at places having a relatively large radius of curvature of the conductors is a maximum.

The radius of curvature along a conductor may vary greatly. Thus, for example, in the case of a cell coil having a spiral shape or a round shape, the first windings have a very small radius of curvature, tending to zero under certain circumstances, while the outer windings have a very large radius of curvature. In this connection, a winding designates a (circular) continuity of a spiral, as is created in response to winding the cell coil of the lithium ion rechargeable battery. A relatively small radius of curvature within the meaning of the invention is a small radius of curvature that is small in comparison with an averaged radius of curvature. Consequently, the inner windings of the cell coil thus have a relatively small radius of curvature. A relatively large radius of curvature within the meaning of the invention is a radius of curvature that is large in comparison with an averaged radius of curvature. Consequently, the outer windings of the cell coil thus have a relatively large radius of curvature. An average radius of curvature within the meaning of this invention is yielded by the curve of radii of curvature along the conductors divided by the number of windings. The averaged radius of curvature thus corresponds to an average radius of curvature of the respective cell coil and is different for each cell coil. According to this refinement, places on the conductors which have a relatively small radius of curvature or which fall below a specified value of the radius of curvature are to be assigned a minimum thickness of the active material. According to this refinement, places on the conductors which have a relatively large radius of curvature or which exceed a specified value of the radius of curvature are to be assigned a minimum thickness of the active material.

According to one refinement of the cell coil, the thickness of the active material varies along the conductor as a function of the mechanical and/or thermal stress acting upon the conductor at the respective location of the active material.

By varying the thickness of the active material along the conductor, as a function of the mechanical or thermal stress acting at the respective location of the active material, loads and stresses of the active material are further avoided.

According to one refinement of the cell coil, the thickness of the active material varies along the conductor in a manner inversely proportional to the mechanical and/or thermal stress acting upon the conductor.

According to one refinement of the cell coil, the thickness of the active material is a maximum at places having the smallest mechanical and/or thermal stress acting on the conductors, and/or the thickness of the active material is a minimum at places having the largest mechanical and/or thermal stress acting on the conductors.

According to one refinement of the cell coil, the thickness of the active material varies in a range of 0 μm to 200 μm, particularly of ≧5 μm to ≦180 μm.

At regions having a maximum stress, a thickness of the active material of 0 μm is preferably provided. Consequently, at these regions flaking off of the active material is no longer possible.

At regions having a minimum stress, a thickness of the active material of 200 μm is provided, since at these points no flaking off of the active material is probable.

Locations which also have low stresses may have about the two-fold to six-fold of the typical layer thickness of a lithium ion rechargeable battery. The maximum thickness of the active material is now limited only by the inner resistance, which rises with the thickness of the active material and by the producibility of very thick active material layers.

The subject matter of the present invention is also a method for producing a cell coil of a lithium ion rechargeable battery, in which, during the application of the active material onto the conductors, the thickness of the active material is varied.

Using this method, a cell coil is produced which has the advantageous properties of the abovementioned cell coil.

According to one refinement of the method, after the application of the active material onto the conductors, the active material is at least partially removed at specified locations.

Using this method, a cell coil may be produced in a particularly simple manner, having a different thickness of the active material. This takes place in that, at specified places, the active material, which was applied before, is removed. This removal is able to take place in different ways.

The regions of the conductors, which are not to have any active material, for example, are able to be coated with a soluble layer, so that the active material does not form there or does not remain stuck there. Subsequent removal of the active material is also possible by using a punch. The active material may further be removed by stamping. A further possibility is to apply the active material, using a stencil, directly at places at which it is desired, and to leave open the places on the conductor that are not to have any active material.

### BRIEF DESCRIPTION OF THE DRAWINGS

FIG. 1 shows a cell coil having a prismatic shape.

FIG. 2 shows the region of great stress of the cell coil shown in FIG. 1, having prismatic shape, in an enlarged representation.

FIG. 3 shows a section of a conductor of the cell coil shown in FIG. 1, having a prismatic shape on which active material has been applied, before the winding of the cell coil.

FIG. 4 shows a cell coil having a spiral shape or a round shape.

FIG. 5 shows a section of a conductor of the cell coil shown in FIG. 4, having a spiral shape or a round shape on which active material has been applied, before the winding of the cell coil.

FIG. 6 shows a cell coil having a square shape or a rectangular shape.

FIG. 7 shows a section of a conductor of the cell coil shown in FIG. 6, having a square shape or a rectangular shape on which active material has been applied, before the winding of the cell coil.

FIGS. 8 to 10 show additional exemplary embodiments of the distribution of the active material on a conductor.

### DETAILED DESCRIPTION OF THE INVENTION

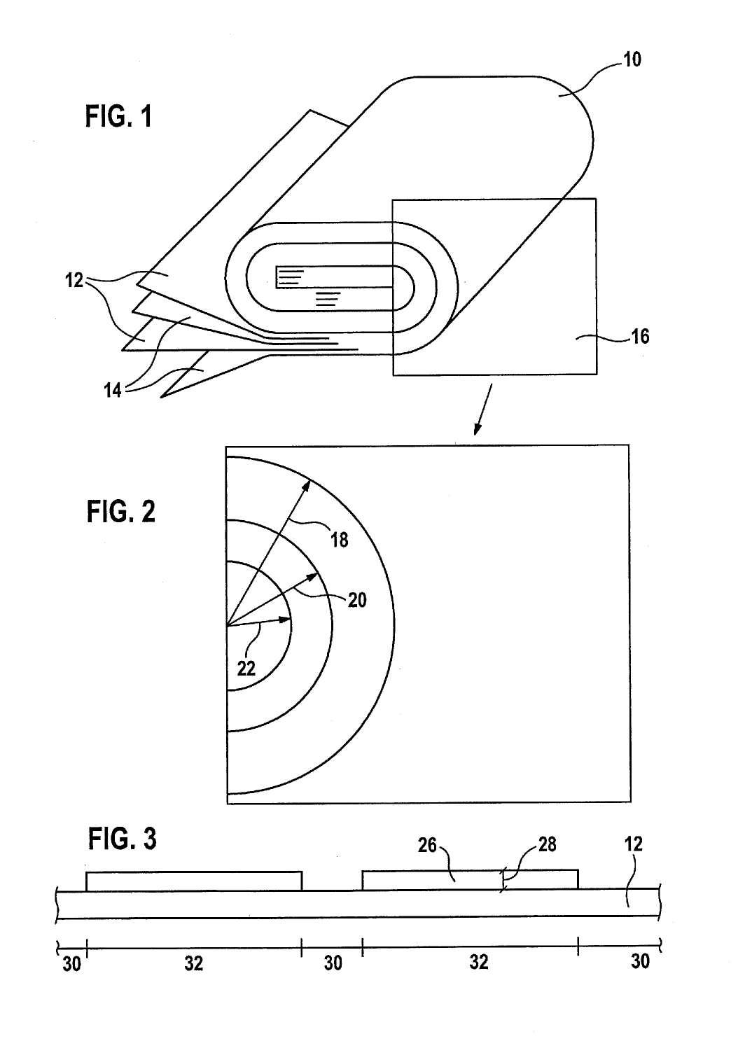

FIG. 1 shows a cell coil 10 having a prismatic shape, which is made up of a total of four layers: two conductors 12 and two separators 14. First conductor 12 represents a positive electrode (a cathode) and is made of aluminum. Second conductor 12 represents a negative electrode (an anode) and is made of copper. The two conductors 12 are coated with active material 26. The two separators 14 are typically made of porous polyethylene and/or polypropylene. The two separators 14 are laid between the two conductors 12 and prevent direct contact of the active materials and thereby prevent a short circuit. Because of the winding of conductors 12 and the operation of cell coil 10, a region 16 is created in the side regions of the cell coil 10, having great stress. In this region 16, active material 26 is greatly stressed mechanically by bending. The narrower the radius of curvature of conductor 12, and the greater the thickness 28 of active material 26, the greater is the mechanical stress. In addition, the active material experiences mechanical stress during the charging and the discharging of the lithium ion rechargeable battery. This takes place based on the volume change that is created by the intercalation/deintercalation of lithium.

FIG. 2 shows region 16 having great stress of cell coil 10 of FIG. 1 in an enlargement. Arrow 20 represents the averaged radius of curvature. Arrow 18 represents a relatively large radius of curvature, which is relatively large compared to the averaged radius of curvature. Arrow 22 represents a relatively small radius of curvature compared to the averaged radius of curvature.

FIG. 3 shows a section of a conductor 12 of cell coil 10, having a prismatic shape, shown in FIG. 1, on which active material 26 has been applied, the active material being shown on only one side of the conductor, to simplify the illustration. The active material is typically applied on both sides of the conductor. The corresponding applies also to FIGS. 5 and 7 through 10. Conductor 12 is in an unrolled state. In the exemplary embodiment shown, no active material 26 has been applied to part 30. Part 30 characterizes a region of the conductor having a relatively small radius of curvature 22, in this context. On part 32, active material 26 has been applied at a constant thickness 28. Part 32 characterizes a region of the conductor having a relatively large radius of curvature 22, in this context.

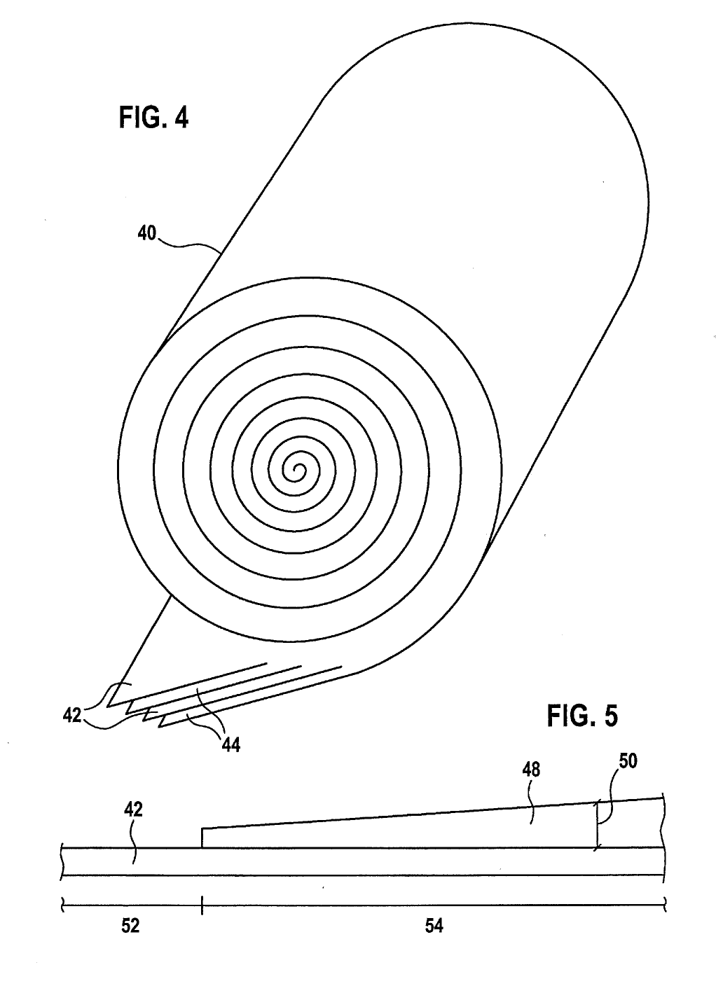

FIG. 4 shows a cell coil 40 having a spiral shape or round shape, which is made up of a total of four layers: two conductors 42 and two separators 44. As may be seen in FIG. 5, the inner windings of cell coil 40 have no active material. Part 52 of conductor 42 characterizes the region of the conductor having a relatively small radius of curvature, as it is present on the inner windings of cell coil 40. Now, while in this part 52 of conductor 42 no active material has been applied, extremely small radii of curvature may be provided. Consequently, a cell coil 40 having a long service life expectancy is able to be produced by simple rolling up. Part 54 of conductor 42 characterizes the region of conductor 42 having a relatively large radius of curvature, as it is present on the outer windings of cell coil 40. On this part 54 active material 48 is applied. In the present exemplary embodiment, thickness 50 of active material 48 is proportional to the radius of curvature. This being the case, thickness 50 of active material 48 increases linearly with the number of windings of the cell coil. Consequently, in an advantageous manner, the entire volume of active material 48 is raised without submitting the active material to unnecessary stresses, which are created by the curvature of the conductors during the winding process. In the ideal case, the stresses may be kept constant during winding, in spite of increasing thickness 50 of active material 48. The volume of active material 48 is the deciding factor for the storage capacity of the lithium ion rechargeable battery. Thickness 50 of active material 48 may have any curve, but may particularly be constant or have an exponential, a concave or a convex curve. The thickness of the active material on the outermost windings preferably increases disproportionately. Thus, in addition, active material may be applied which, because of its increased volume change, has no effect on the regions of the active material that lie farther inward. The end of part 52 of conductor 42, which characterizes the region of conductor 42 by having a relatively small radius of curvature, and the beginning of part 54 of conductor 42 which characterizes the region of conductor 42 by having a relatively large radius of curvature, may be selected at will. Part 54 of conductor 42 preferably begins when the radius of curvature has reached or exceeded a predetermined boundary value, and, with that, the mechanical stresses resulting from the curvature have reached or exceeded a predetermined boundary value. The beginning of the active material is abrupt, as shown in FIG. 5. A thickness 50 of active material 48, beginning at 0 μm and increasing steadily, is also of advantage. This has the advantage that, during the winding, no gaps are created between the windings of cell coil 40. Alternatively, part 52 of conductor 42 may be omitted, so that thickness 50 of active material 48 increases continuously from beginning to end.

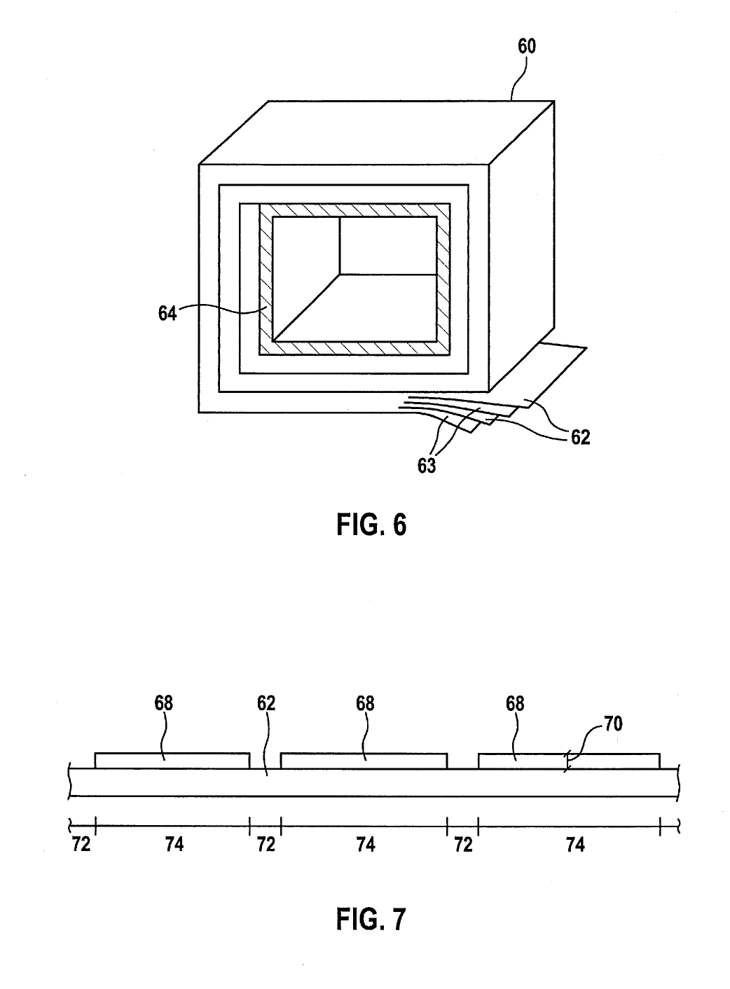

FIG. 6 shows a cell coil 60 having a square or rectangular shape, which is made up of four layers: two conductors 62 and two separators 63. The four layers are wound around a cell center 64 having a square or rectangular shape. FIG. 7 shows a section of a conductor 62 of cell coil 60 shown in FIG. 6, on which active material 68 has been applied. Conductor 62 is in an unrolled state in FIG. 7.

On part 72 of conductor 62, which characterizes the region of conductor 62 by having a relatively small radius of curvature, no active material has been applied. Consequently, conductor 62 may be buckled in this region and may follow the square or rectangular shape of the cell center closely. On part 74 of conductor 62, which characterizes the region of conductor 62 by having a relatively small radius of curvature, active material 68 has been applied. The length of part 54 of conductor 62, at the inner windings of the cell coil, corresponds to the length of the sides of cell coil 64. Going towards the outside, the length of part 74 of conductor 62 becomes longer.

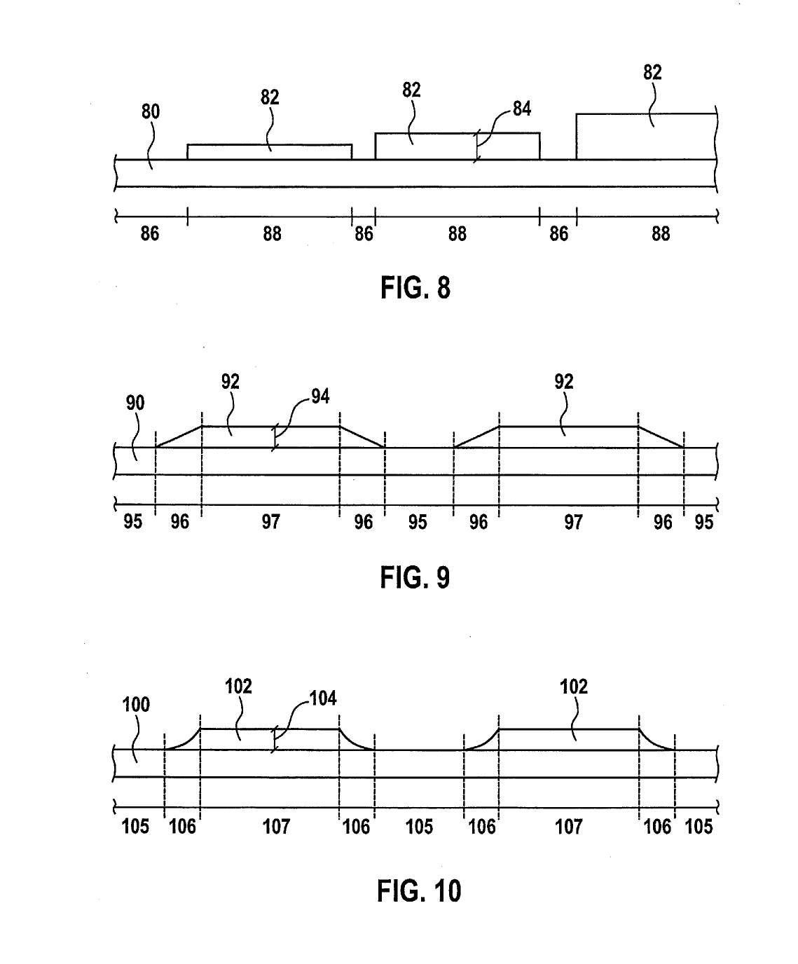

FIGS. 8 to 10 show additional exemplary embodiments for the distribution of the active material on a conductor.

FIG. 8 shows the distribution of active material 82 on a conductor 80. Thickness 84 of active material 82 is constant over part 88 of conductor 80, which characterizes the region of conductor 80 by a relatively large radius of curvature. However, thickness 84 of active material 82 increases from a part 88 of conductor 80 to next part 88 of conductor 80. On part 86 of the conductor, which characterizes the region of conductor 80 by having a relatively small radius of curvature, no active material 82 has been applied. Active material 82 is applied onto conductor 80 in a step-wise manner, the distance between each active material 82 or the length of part 86 of conductor 80 increasing. Consequently, for instance, by simple folding, one is able to produce a cell coil having a prismatic shape.

FIG. 9 shows the distribution of active material 92 on a conductor 90. Parts 96 of conductor 90 may be seen having a relatively average radius of curvature. A relatively average radius of curvature within the meaning of the present invention is a radius of curvature which corresponds to the averaged radius of curvature or deviates from it only slightly, and thereby defines a transition range from a relatively small radius of curvature to a relatively large radius of curvature. A linear increase in thickness 94 of active material 92, beginning at 0 μm is provided in this case. A linear decrease in thickness 94 of active material 92 is provided at the end of active material 92. By this shaping of active material 92, gaps within the cell coil are able to be avoided.

FIG. 10 shows the distribution of active material 102 on a conductor 100. Parts 106 of conductor 100 may be seen having a relatively average radius of curvature. An exponential or a concave curve of thickness 104 of the active material, beginning at 0 μm is provided in this case.

1-10. (canceled)

11. A cell coil of a lithium ion rechargeable battery, comprising:
at least two conductors;
at least two separators, wherein the conductors are separated from one another by the separators; and
an active material applied onto the conductors, wherein a thickness of the active material varies along the conductors.

12. The cell coil as recited in claim 11, wherein the thickness of the active material varies along the conductors as a function of the radius of curvature of the conductors.

13. The cell coil as recited in claim 12, wherein the thickness of the active material varies along the conductors in proportion to the radius of curvature of the conductors.

14. The cell coil as recited in claim 12, wherein a minimum thickness of the active material is present at a location corresponding to a first radius of curvature of the conductors, and a maximum thickness of the active material is present at a location corresponding to a second radius of curvature of the conductors, the first radius of curvature of the conductors being smaller than the second radius of curvature of the conductors.

15. The cell coil as recited in claim 11, wherein the thickness of the active material varies along the conductors as a function of at least one of a mechanical stress and a thermal stress acting upon different points along the conductors.

16. The cell coil as recited in claim 15, wherein the thickness of the active material varies along the conductors inversely proportional to at least one of the mechanical stress and the thermal stress acting upon the conductors.

17. The cell coil as recited in claim 15, wherein at least one of:
(i) the thickness of the active material is a maximum at places having at least one of the smallest mechanical stress and the smallest thermal stress acting upon the conductors; and
(ii) the thickness of the active material is a minimum at places having at least one of the largest mechanical stress and the smallest thermal stress acting upon the conductors.

18. The cell coil as recited in claim 17, wherein the thickness of the active material varies within a range of ≧5 μm to ≦180 μm.

19. A method for producing a cell coil of a lithium ion rechargeable battery, comprising:
providing at least two conductors separated by at least two separators; and
applying an active material onto the conductors, wherein a thickness of the active material is varied during the application of the active material onto the conductors.

20. The method as recited in claim 19, wherein, after the application of the active material onto the conductors, the active material is at least partially removed at predetermined places.
